(19) United States
(12) Patent Application Publication
(10) Pub. No.: US 2007/0050798 A1
(43) Pub. Date: Mar. 1, 2007

(54) Guide shaft holding mechanism and optical disk drive comprising the same

(75) Inventor: Kazuhiro Watanabe, Echizen-city (JP)

Correspondence Address: JORDAN AND HAMBURG LLP, 122 EAST 42ND STREET, SUITE 4000, NEW YORK, NY, 10168, US

(73) Assignee: ORION ELECTRIC Co., Ltd., Echizen-city (JP)

(21) Appl. No.: 11/508,720

(22) Filed: Aug. 23, 2006

(30) Foreign Application Priority Data
Aug. 31, 2005 (JP) 2005-251456

(51) Int. Cl. G11B 7/00

(52) U.S. Cl. 720/677

(57) ABSTRACT

According to the present invention, means for preventing guide shafts from being extracted in an axial direction is configured by providing end face contact pieces formed by cutting and electing a chassis plate and contacting the end face contact pieces with end faces of the guide shafts. The guide shafts are held by hook-shaped shaft holding members formed by cutting and erecting the chassis plate, where the guide shafts are passed through cut-out portions of the shaft holding members. The end faces of adjusting screws threaded into screw holes from a lower surface of the chassis plate and protruding upward are broght in contact with the guide shafts. The adjusting screws prevent the guide shafts from being extracted through insertion openings, and adjust heights thereof. Thereby, holding and height adjustment of the guide shafts for the pickup unit are performed with a smaller number of parts, low cost, and ease. In addition, the guide shafts are prevented from being extracted even when a strong impact is applied.

### CROSS REFERENCE TO RELATED APPLICATION

The disclosure of Japanese Patent Applications enumerated below including specification, drawings and claims is incorporated herein by reference in its entirety:

No. 2005-251456 filed Aug. 31, 2005.

### BACKGROUND OF THE INVENTION

1. Field of the Invention

The present invention relates to a guide shaft holding mechanism which holds a guide shaft for a pickup unit for an optical disk on a chassis plate, and an optical disk drive comprising the guide shaft holding mechanism.

2. Description of the Related Art

There is an optical disk drive which records or reproduces a so-called optical disk, such as a DVD, a CD or the like, which is a storage medium for recording information or a storage medium on which information is previously recorded. For example, the optical disk drive comprises a tray on which an optical disk (medium) is placed and allows a disk loading/unloading operation in and out of the optical disk drive, a turntable which slightly holds up the optical disk housed in the optical disk drive in association with the loading action of the tray, thereby making it possible to rotate the optical disk, a clamper which is opposed to the turntable and sandwiches the disk with the turntable, an optical pickup unit which emits laser light onto a recording surface of the optical disk rotated while being sandwiched and held by the turntable and the clamper, so as to record information onto the recording surface or read information from the recording surface, a guide shaft which controls a movement direction of the pickup unit, and a chassis plate made of a metal to which the turntable, the pickup unit, the guide shaft, and the like are attached into a single unit. These various parts are assembled with an outer casing which provides an outer appearance of the optical disk drive. The optical disk drive may be incorporated as a reproducing or recording/reproducing unit into various electronic apparatuses.

A unit obtained by the turntable, the optical pickup unit, the guide shaft and the like as major parts to the chassis plate is generally called a traverse unit. The traverse unit is assembled into the outer casing in a manner which allows the traverse unit to swing around an end thereof as a pivot point.

Regarding the optical pickup unit attached to the traverse unit, a pair of guide shafts which are provided in parallel on left and right sides of the chassis plate, support the pickup unit in a manner which allows the pickup unit to freely linearly reciprocate so as to irradiate the optical disk on the rotating turntable with laser light while moving back and forth in a radial direction (traverse direction).

In this case, it is important for both the guide shafts to support the optical pickup unit horizontally at a reference height with high accuracy. Therefore, the following guide shaft holding mechanisms for holding the guide shaft on the chassis plate have been proposed.

Specifically, according to a proposed exemplary guide shaft holding mechanism, two bearings having U-shaped vertical and horizontal grooves, respectively, hold end portions of a guide shaft while avoiding extraction of the guide shaft, and adjust a height of the guide shaft by adjusting an amount of advance of a skew screw from the top. Alternatively, a vertical screw hole is provided at the end portion of the guide shaft, and the height of the guide shaft is adjusted by adjusting an amount of helical advance into the screw hole of the screw from the top (e.g., Japanese Patent Laid-Open Publication No. 2004-95143).

According to another proposed exemplary guide shaft holding mechanism, a portion of the chassis plate near the end portion of the guide shaft is cut and erected to form each of a positioning piece and a fixing piece having complicated shapes so as to reduce the number of parts, and the fixing piece is bent so that the end portion is sandwiched and held by the positioning piece and the fixing piece at a desired height, thereby holding the guide shaft and adjusting the height thereof (e.g., Japanese Patent Laid-Open Publication No. 2002-50137).

### SUMMARY OF THE INVENTION

When such a guide shaft holding mechanism has the former exemplary structure, the shaft holding portion is formed by so-called outsert molding, resulting in high cost of the part alone. In addition, the shape of a mold required for molding of the part is complicated, leading to a reduction in the life of the mold.

In the case of the latter exemplary structure, although the shaft holding portion is formed by cutting and erecting the chassis plate, so that the number of parts can be reduced and the cost can be suppressed, it is necessary to cut and erect a complicated shape from the chassis plate, and bend the cut piece (fixed piece) to adjust the height of the guide shaft and sandwich and hold the guide shaft. Therefore, it is considerably difficult to achieve high-precision adjustment and reliable holding.

In such a guide shaft holding mechanism, there is a demand not only for inexpensive and easy holding and height adjustment of the guide shaft with a reduced number of parts, but also for prevention of the guide shaft from being extracted or dislocated even when a strong impact is applied by a so-called drop test.

An object of the present invention is to achieve inexpensive and easy holding and height adjustment of a guide shaft with a reduced number of parts, and prevention of the guide shaft from being extracted or dislocated even when a strong impact is applied.

To achieve the objects, a guide shaft holding mechanism according to a first aspect of the present invention is provided for holding a guide shaft over a chassis plate, the guide shaft supports a pickup unit for an optical disk over the chassis plate in a manner which allows the pickup unit to freely linearly reciprocate. The mechanism comprises an end face contact piece formed by cutting and erecting a portion of the chassis plate near an end face of the guide shaft, and contacting the end face of the guide shaft to serve as means for preventing the guide shaft from being extracted in an axial direction, a hook-shaped shaft holding member formed by cutting and erecting a portion of the chassis plate closer to a center of the chassis plate than the end face of the guide shaft into a shape having a cut-out portion through which the guide shaft is passed in an engaged state and cutting away a lower portion of either a left or right side of a closed frame of the cut-out portion into an insertion opening through which the guide shaft is inserted into the cut-out portion, and an adjusting screw for preventing the guide shaft from being extracted through the insertion opening and adjusting a height of the guide shaft. A screw hole is provided immediately below the guide shaft near the shaft holding member of the chassis plate, and the adjusting screw is threaded into the screw hole from a lower surface of the chassis plate, and an end face of the adjusting screw protruding upward from the screw hole contacts the guide shaft.

Therefore, according to the guide shaft holding mechanism of the first aspect of the present invention, the end face contact piece formed by cutting and erecting the chassis plate provides means for preventing the guide shaft of the pickup unit from being extracted in the axial direction (front-to-rear direction).

Also, the guide shaft is engaged with and passed through the cut-out portion of the hook-shaped shaft holding member formed by cutting and erecting the chassis plate, thereby holding the guide shaft over the chassis plate.

The adjusting screw is threaded into the screw hole of the chassis plate from the lower surface of the chassis plate so that the end face contacts the guide shaft. Thereby, the shaft holding member and the adjusting screw provide means for preventing the guide shaft from being extracted in upward and downward directions and leftward and rightward directions perpendicular to the axial direction. Also, the adjusting screw prevents the guide shaft from being extracted through the insertion opening of the shaft holding member and adjusts the height of the guide shaft.

In this case, a shaft holding portion is not formed by so-called outsert molding, and the end face contact piece and the shaft holding member formed by cutting and erecting (bending) the chassis plate are used to configure the guide shaft holding mechanism, thereby making it possible to hold the guide shaft over the chassis plate without increasing the number of parts and low cost.

In this case, the end face contact piece can be considerably easily formed by cutting and erecting the chassis plate into a shape of, for example, a tongue or the like. The shaft holding member can also be easily formed by cutting and erecting the chassis plate into a shape having an O-shaped cut-out portion (hollow portion) and cutting away a lower portion of either a left or right side of the closed frame of the cut-out portion into a hook shape. The guide shaft can be easily slid and fitted into the cut-out portion through the insertion opening formed by the cutting away, thereby making it possible to easily hold the guide shaft over the chassis plate.

With these cut-and-erected parts and the adjusting screw, the guide shaft held over the chassis plate can be three-dimensionally prevented from being extracted in the back and forth directions, the left and right directions, and the upward and downward directions, even when a strong impact is applied due to a drop test or the like.

Also, by helically inserting the adjusting screw from the lower surface of the chassis plate and adjusting an amount of protrusion of the end face of the adjusting screw from the chassis plate, the height of the guide shaft can be adjusted easily and with high precision.

Therefore, it is possible to provide a guide shaft holding mechanism in which holding and height adjustment of a guide shaft of a pickup can be performed with low cost and ease and without increasing the number of parts, and the guide shaft is prevented from being dislocated even when a strong impact is applied.

According to a second aspect of the present invention, in the guide shaft holding mechanism of the first aspect of the present invention, the end face contact piece, the shaft holding member, and the adjusting screw are provided near each end portion of the guide shaft, and the screw hole is formed near each end portion of the guide shaft.

Therefore, according to the guide shaft holding mechanism of the second aspect of the present invention, the guide shaft holding mechanism of the first aspect of the present invention is provided near each end portion of the guide shaft, so that it is possible to perform holding, extraction prevention and height adjustment of the guide shaft at both the ends of the guide shaft, as in the guide shaft holding mechanism of the first aspect of the present invention.

According to a third aspect of the present invention, in the guide shaft holding mechanism of the first or second aspect of the present invention, a spring for pressing a portion near the end face of the guide shaft in a downward direction is provided.

Therefore, according to the guide shaft holding mechanism of the third aspect of the present invention, the spring is added to the structure of the first or second aspect of the present invention. Since the guide shaft is pressed in the downward direction by the spring, the effect of preventing extraction when a strong impact is applied due to a drop test or the like, can be further improved.

A guide shaft holding mechanism according to a fourth aspect of the present invention is provided for holding a pair of guide shafts which are provided in parallel on left and right sides of a pickup unit for an optical disk and supports the pickup unit over a chassis plate in a manner which allows the pickup unit to freely linearly reciprocate. The mechanism comprises a fixing holder member for fixing and holding one end portion of one of the guide shafts at a reference height over the chassis plate, an end face contact piece formed by cutting and erecting a portion of said chassis plate near the end face of the guide shaft, and contacting the end face of the guide shaft to serve as means for preventing the guide shaft from being extracted in an axial direction, wherein the end face contact piece is provided at the other end portion of the one guide shaft and both end portions of the other guide shaft, a hook-shaped shaft holding member formed by cutting and erecting a portion closer to a center of the chassis plate than the end face of the guide shaft into a shape having a cut-out portion through which the guide shaft is passed in an engaged state and cutting away a lower portion of either a left or right side of a closed frame of the cut-out portion into an insertion opening through which the guide shaft is inserted into the cut-out portion, wherein the shaft holding member is provided at the other end portion of the one guide shaft and both end portions of the other guide shaft, and an adjusting screw for preventing the guide shaft from being extracted through the insertion opening and adjusting a height of the guide shaft. A screw hole is provided immediately below the guide shaft near the shaft holding member of the chassis plate, and the adjusting screw is threaded into the screw hole from a lower surface of the chassis plate, and an end face of the adjusting screw protruding upward from the screw hole contacts the guide shaft.

Therefore, according to the guide shaft holding mechanism of the fourth aspect of the present invention, for the pair of guide shafts provided in parallel on the left and right sides of the pickup unit, one end of one of the guide shafts can be fixed and held at the reference height over the chassis plate by the fixing holder member.

Also, the other end of the one guide shaft and the other end of the other guide shaft can be held over the chassis plate while being three-dimensionally prevented from being extracted and being adjusted to the reference height, by the structure of the end face contact piece, the shaft holding member, the screw hole, and the adjusting screw which are formed by cutting and erecting the chassis plate.

Therefore, holding over the chassis plate and height adjustment of the pair of guide shafts provided on the left and right sides of the pickup can be performed with low cost and ease and without increasing the number of parts. In addition, both the guide shafts are prevented from being extracted even when a strong impact is applied. Thus, it is possible to provide a considerably practical guide shaft holding mechanism.

Further, the present invention provides an optical disk drive comprising the guide shaft holding mechanism according to any one of the first to fourth aspects of the present invention.

Therefore, according to the optical disk drive comprising the guide shaft holding mechanism of the present invention, since the guide shaft holding mechanism of any one of the first to fourth aspects of the present invention is provided, holding and height adjustment of the guide shaft for supporting the pickup unit can be performed with low cost and ease and without increasing the number of parts. In addition, the guide shaft is prevented from being extracted or dislocated even when a strong impact is applied, thereby further improving performance, reliability and the like with low cost.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a perspective view illustrating a state of an optical disk drive according to an embodiment of the present invention when a tray is loaded, where an upper portion of the optical disk drive is cut away.

FIG. 2 is a perspective view illustrating a state of the optical disk drive of the embodiment of the present invention when the tray is unloaded.

FIG. 3 is a perspective view singly illustrating a traverse unit according to the embodiment of the present invention.

FIG. 4 is a perspective view illustrating a state that a guide shaft is attached to one side of a chassis plate in the embodiment of the present invention.

FIG. 5 is an enlarged perspective view illustrating a portion A indicated with a dash-dot-dot line in FIG. 4.

FIG. 6 is an enlarged perspective view illustrating a portion B indicated with a dash-dot-dot line in FIG. 4.

FIG. 7A is a plan view illustrating a state that a guide shaft is attached to one side of a chassis plate in the embodiment of the present invention.

FIG. 7B is a cross-sectional side view, taken along line c1-c2 of FIG. 7A.

### DETAILED DESCRIPTION OF THE PREFERRED EMBODIMENT

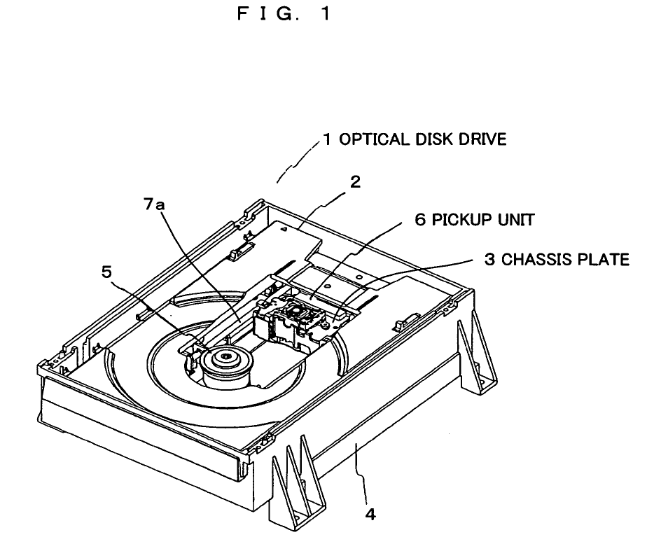

Hereinafter, in order to describe the present invention in greater detail, an embodiment thereof will be described with reference to FIGS. 1 to 6 and FIGS. 7A and 7B.

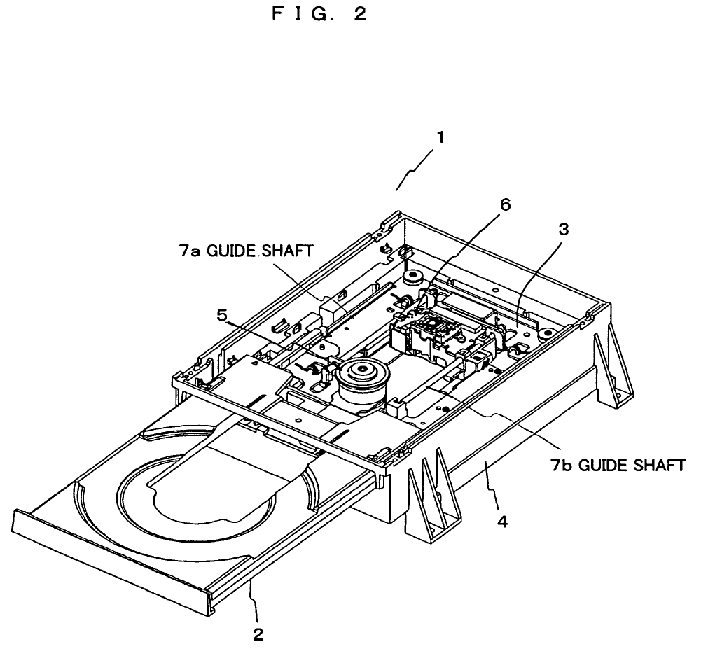

FIGS. 1 and 2 illustrate a state of an optical disk drive when a top plate (plate) and a clamper are removed so that the optical disk drive is open outward. FIG. 1 is a perspective view illustrating a state of the optical disk drive when a tray is loaded in the optical disk drive. FIG. 2 is a perspective view illustrating a state of the optical disk drive when the tray is unloaded out of the optical disk drive.

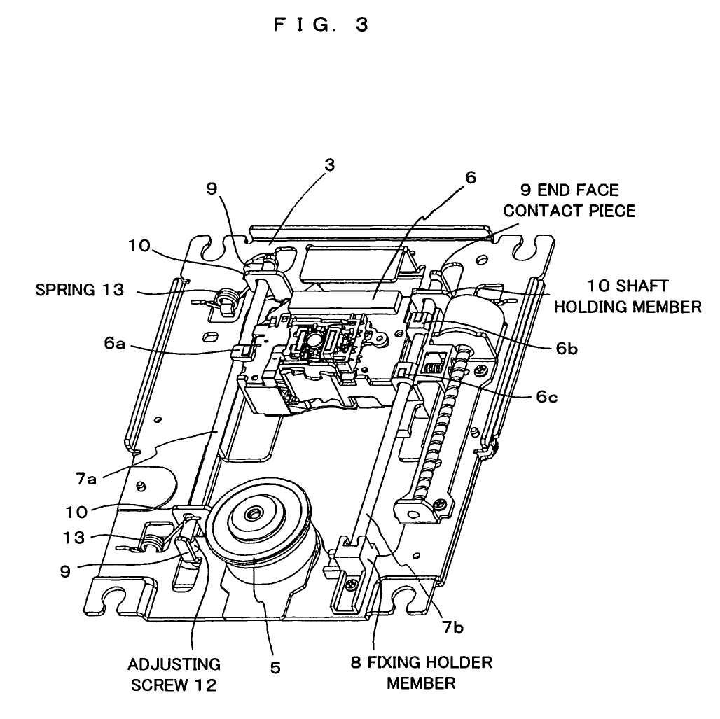

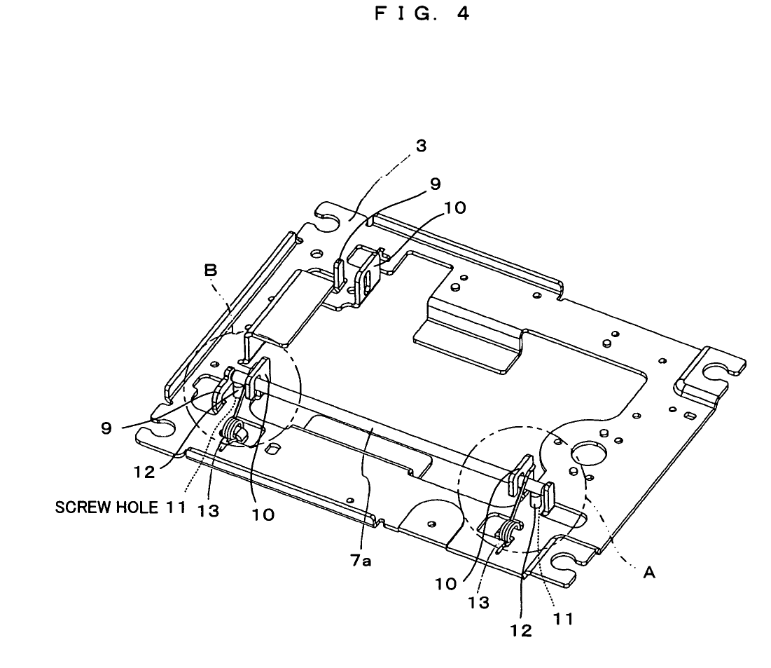

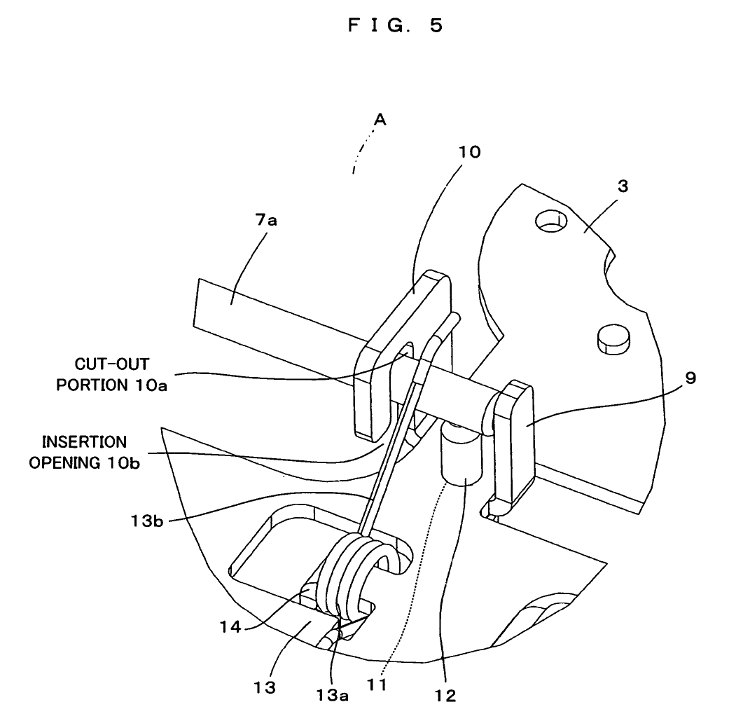

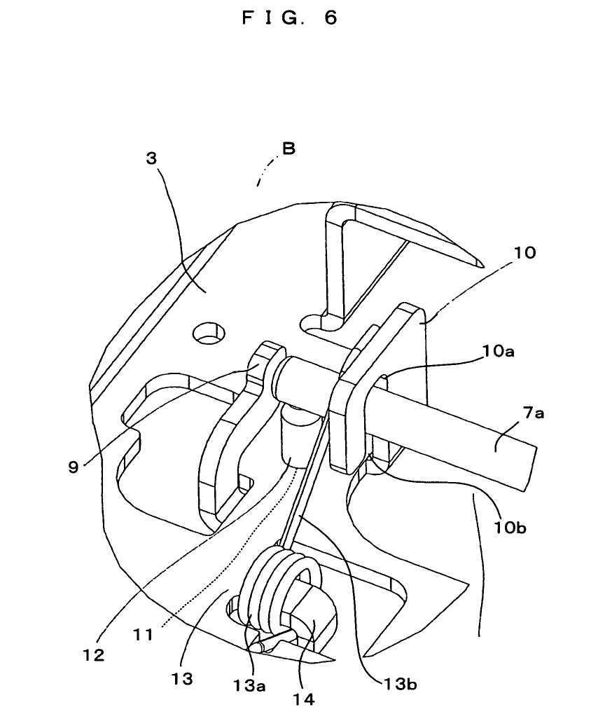

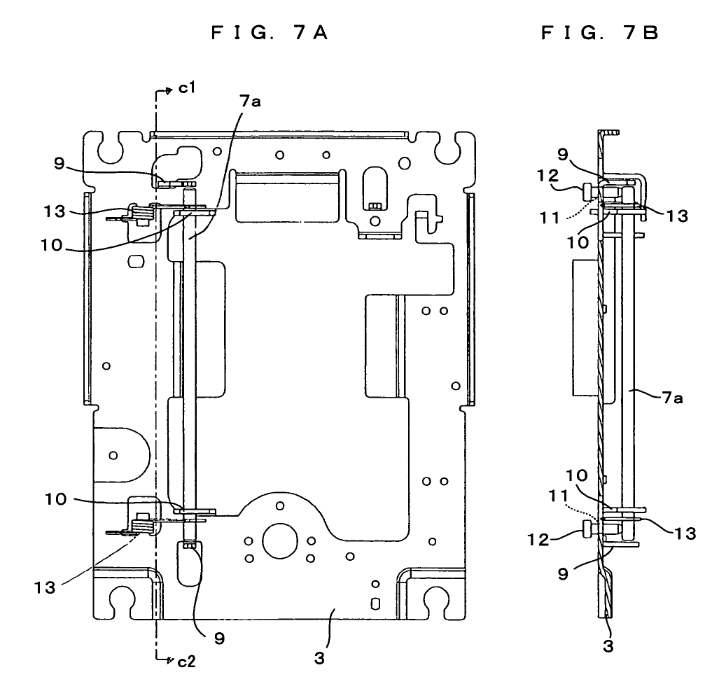

FIG. 3 is a perspective view singly illustrating a traverse unit which is attached inside the optical disk drive. FIG. 4 is a perspective view illustrating a state that a guide shaft is attached to one side of a chassis plate. FIG. 5 is an enlarged perspective view illustrating a portion A indicated with a dash-dot-dot line in FIG. 4. FIG. 6 is an enlarged perspective view illustrating a portion B indicated with a dash-dot-dot line in FIG. 4. FIG. 7A is a plan view illustrating a state that a guide shaft is attached to one side of the chassis plate. FIG. 7B is a cross-sectional side view, taken along line c1-c2 of FIG. 7A.

As illustrated in FIGS. 1 and 2, an optical disk drive 1 of the embodiment has a function of reproducing or recording/reproducing an optical disk, such as a DVD, a CD or the like. On a chassis plate 3 in a main body frame 4 which is made of a synthetic resin and is open upward, for example, a turntable 5 which holds up and rotates an optical disk which is loaded by a tray 2 from the outside of an electronic apparatus comprising the optical disk drive 1, a pickup unit 6 which emits laser light onto a recording surface of the optical disk on the turntable 5 so as to record or reproduce the optical disk, a pair of guide shafts 7a and 7b which are provided in parallel on left and right sides of the pickup unit 6, and the like, are provided.

The chassis plate 3 is formed of a metal plate (an iron plate, etc.) as with a chassis included in well-known traverse units. An end (rear end) of the chassis plate 3 is linked to the main body frame 4. Around the linking portion as a pivot point, the other end (front end) of the chassis plate 3 can be swung vertically. When the tray 2 is unloaded out of the electronic apparatus before an optical disk is loaded (inserted), the chassis plate 3 is swung downward (forwardly inclined) around the linking portion as a pivot point. When an optical disk is loaded from the outside of the electronic apparatus to a predetermined position of the main body frame 4 by the tray 2, the forwardly inclined chassis plate 3 is swung around the linking portion of the main body frame 4 as a pivot point, back to a horizontal state.

In this case, the optical disk placed on the tray 2 is slightly held up by the turntable 5 which is lifted in association with the swinging action of the chassis plate 3. When the chassis plate 3 is in the horizontal state, the optical disk can be recorded and reproduced.

Both the guide shafts 7a and 7b are formed of, for example, a metal, and allow the pickup unit 6 to linearly reciprocate in a radial direction (front-to-rear direction) of the optical disk within a range from an inner circumferential end to an outer circumferential end of the optical disk. Therefore, the guide shafts 7a and 7b are provided in parallel on left and right sides of the pickup unit 6, and are passed through support protrusions 6a to 6c provided on left and right sides of the pickup unit 6 so that the pickup unit 6 is supported in a manner which allows the pickup unit 6 to slide while floating over the chassis plate 3 as illustrated in FIG. 3.

Both the guide shafts 7a and 7b are attached to the chassis plate 3 by a guide shaft holding mechanism as described below.

Specifically, in the case of the embodiment, since the front end of the guide shaft 7b is used as a reference for height, the front end is positioned and fixed as follows. As illustrated in FIG. 3, a fixing holder member 8 made of a resin is fixed to the chassis plate 3 with a screw. The front end of the guide shaft 7b is fitted into a holding hole (horizontal hole) at a reference height position of the fixing holder member 8. Therefore, the front end is positioned and fixedly held at the reference height from an upper surface of the chassis plate 3.

The front and rear ends of the guide shaft 7a and the rear end of the guide shaft 7b are held at the reference height position in a manner which prevents the guide shafts 7a and 7b from being extracted and adjusts the heights thereof, by end face contact pieces 9 and shaft holding members 10 which are formed by cutting and erecting the chassis plate 3, and adjusting screws 12 which are threaded into screw holes 11 of the chassis plate 3 from the bottom and contacts the guide shaft 7a or 7b via end faces thereof, as illustrated in FIG. 3.

In this case, the contact pieces 9 provided at the end faces are in the shapes of a tongue piece (the front ends of the guide shafts 7a and 7b (FIG. 5)) and an arm (the rear end of the guide shaft 7b (FIG. 6)), i.e., these shapes are somehow different from each other, but all of them are each formed by cutting and erecting a portion of the chassis plate 3 near an end face of the guide shaft 7a or 7b. These contact pieces 9 contact the respective end faces of the guide shafts 7a and 7b, serving as means for preventing the guide shafts 7a and 7b from being extracted in an axial direction (front-to-rear direction).

The shaft holding members 10 have the same hook shape as illustrated in FIGS. 5 and 6. Portions closer to a center of the chassis plate 3 than the end faces of the guide shafts 7a and 7b are cut and erected into shapes having an O-shaped cut-out portion 10a through which the guide shafts 7a and 7b are passed in the engaged state. A lower portion of either a left or right side (left side in FIGS. 5 and 6) of a closed frame of the cut-out portion 10a is cut away to form an insertion opening 10b through which the guide shafts 7a and 7b are inserted into the cut-out portion 10a.

The guide shafts 7a and 7b are slid and fitted through the insertion openings 10b into the cut-out portions 10a of the respective shaft holding members 10 with ease, so that the guide shafts 7a and 7b are held over the chassis plate 3 by the respective shaft holding members 10.

Also, as illustrated in FIGS. 7A and 7B, the screw holes 11 are provided immediately below the guide shafts 7a and 7b near the respective shaft holding members 10 of the chassis plate 3. The adjusting screws 12 are used to prevent the guide shafts 7a and 7b from being extracted through the insertion openings 10b and adjust the heights of the guide shafts 7a and 7b. The adjusting screws 12 are threaded into the respective screw holes 11 from a lower surface of the chassis plate 3, and end faces thereof protruding upward from the screw holes 11 contact the respective guide shafts 7a and 7b.

The shaft holding members 10 and the adjusting screws 12 provide means for preventing the guide shafts 7a and 7b from being extracted in leftward and rightward directions and upward and downward directions.

Therefore, the end face contact pieces 9, the shaft holding members 10, which are parts obtained by cutting and erecting the chassis plate 3, and the adjusting screws 12, three-dimensionally prevent the guide shafts 7a and 7b held over the chassis plate 3 from being extracted in the back and forth directions, the leftward and rightward directions, and the upward and downward directions. Therefore, the guide shafts 7a and 7b are not extracted or dislocated even when a strong impact is applied due to a drop test or the like. Note that, regarding the front end of the guide shaft 7b held by the fixing holder member 8 is not extracted.

By adjusting an amount of protrusion of the end face of each adjusting screw 12 from the chassis plate 3, the heights of the guide shafts 7a and 7b can be set to be the reference heights at all the end portions easily and with high precision. Thus, the height of the pickup unit 6 can be easily adjusted with high precision.

Therefore, a shaft holding part formed by so-called outsert molding is not used, and the end face contact pieces 9 and the shaft holding members 10 formed by cutting and erecting (bending) the chassis plate 3 can be used to hold the guide shafts 7a and 7b over the chassis plate 3 with a smaller number of parts and low cost. In addition, these cut-and-erected parts and the adjusting screws 12 (i.e., a smaller number of parts) can be used to hold the guide shafts 7a and 7b for the pickup 6 and adjust the heights thereof with a smaller number of parts, low cost, and ease. In this case, the screw holes 11 are formed in the flat chassis plate 3, but not in the guide shafts 7a and 7b, i.e., can be easily formed.

Even when a strong impact is applied due to a drop test or the like to the optical disk drive 1 alone or in a product (electronic apparatus), the guide shafts 7a and 7b are not extracted or dislocated. Thus, the performance, reliability and the like thereof can be improved with a low-cost structure.

In the embodiment, as illustrated in FIGS. 3 and 4 and the like, regarding at least the guide shaft 7a, springs 13 which press portions near the end faces of the guide shaft 7a are provided at both ends of the guide shaft 7a.

The coil portion 13a of the spring 13 is wound and held around a holder piece 14 which is formed by cutting and erecting the chassis plate 3 and bending it into a ring shape. A pressing piece 13b at a tip of the spring 13 presses an upper surface of the guide shaft 7a in a downward direction.

By further pressing the guide shaft 7a in the downward direction using the spring 13, the effect of preventing the guide shaft 7a from being extracted when a strong impact is applied due to a drop test or the like, is further improved.

Next, an exemplary procedure for attaching the guide shafts 7a and 7b to the chassis plate 3 will be described.

When the guide shafts 7a and 7b are attached to the chassis plate 3, the chassis plate 3 is initially turned upside down so that the end face contact pieces 9 and the shaft holding members 10 formed by cutting and erecting the chassis plate 3 face downward. The guide shafts 7a and 7b are pushed into the cut-out portions 10a through the insertion openings 10b of the shaft holding members 10.

After the guide shafts 7a and 7b are temporarily attached to and held by the chassis plate 3, the adjusting screws 12 are threaded into the respective screw holes 11 of the chassis plate 3 to fix the guide shafts 7a and 7b so that the guide shafts 7a and 7b are prevented from being dislocated from the chassis plate 3.

Thereafter, the chassis plate 3 is reversed back to a normal position (the end face contact pieces 9 and the shaft holding members 10 face upward), the springs 13 are attached and the screwed state of each adjusting screw 12 is adjusted to adjust the amount of protrusion of the end face, thereby adjusting the guide shafts 7a and 7b to appropriate heights, and ending the attachment.

As described above, in the case of the embodiment, a novel guide shaft holding mechanism can be provided in which the guide shafts 7a and 7b for the pickup unit 6 can be held and the heights thereof can be adjusted with a smaller number of parts, low cost, and ease, and in addition, even when a strong impact is applied, the guide shafts 7a and 7b are not extracted or dislocated. Also, it is possible to provide the optical disk drive 1 which comprises this holding mechanism, thereby simplifying the step of attaching the pickup unit 6 and the like, improving assembly workability, and inexpensively improving performance, reliability and the like.

Note that the end face contact pieces 9 and the shaft holding members 10 are formed of the chassis plate 3, the chassis plate 3 is made only of a metal plate, and outsert molding for holding the guide shafts 7a and 7b is not required. Therefore, not only the cost of the chassis plate 3 can be reduced, but also a die for the chassis plate 3 is simplified so that the forming life of the die can be improved.

The present invention is not limited to the above-described embodiment. Other changes can be made without departing the spirit and scope of the present invention. For example, the front end of the guide shaft 7b may be held by a structure similar to that for the end of the guide shaft 7a, but not by the fixing holder member 8. Conversely, an end of the guide shaft 7a may be held by a fixing holder member 8 similar to the fixing holder member 8.

In the embodiment, a total of the three end portions of a pair of the guide shafts 7a and 7b are held by the end face contact pieces 9, the shaft holding members 10, and the adjusting screws 12, the remaining one end portion is held by the fixing holder member 8 made of a resin apart from the chassis plate 3, and the fixing holder member 8 is used to determine the reference height of the guide shafts 7a and 7b so as to position the pickup unit 6. Alternatively, a holder member substituting for the fixing holder member 8 may be integrally formed with the chassis plate 3, or a total of the four end portions of the guide shafts 7a and 7b may be held by the end face contact pieces 9, the shaft holding members 10, and the adjusting screws 12.

The spring 13 may also be provided at an end portion of the guide shaft 7b.

The present invention can be applied to various guide shaft holding mechanisms for pickup units of optical disk drives which are, for example, to be incorporated into electronic apparatuses, and optical disk drives comprising the guide shaft holding mechanisms.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

1. A guide shaft holding mechanism for holding a guide shaft over a chassis plate, said guide shaft supports a pickup unit for an optical disk over the chassis plate in a manner which allows said pickup unit to freely linearly reciprocate, comprising:
an end face contact piece formed by cutting and erecting a portion of said chassis plate near an end face of said guide shaft, and contacting the end face of said guide shaft to serve as means for preventing said guide shaft from being extracted in an axial direction;
a hook-shaped shaft holding member formed by cutting and erecting a portion of said chassis plate closer to a center of said chassis plate than the end face of said guide shaft into a shape having a cut-out portion through which said guide shaft is passed in an engaged state and cutting away a lower portion of either a left or right side of a closed frame of said cut-out portion into an insertion opening through which said guide shaft is inserted into said cut-out portion; and
an adjusting screw for preventing said guide shaft from being extracted through said insertion opening and adjusting a height of said guide shaft,
wherein a screw hole is provided immediately below said guide shaft near said shaft holding member of said chassis plate, and said adjusting screw is threaded into said screw hole from a lower surface of said chassis plate, and an end face of said adjusting screw protruding upward from said screw hole contacts said guide shaft.

2. The guide shaft holding mechanism according to claim 1, wherein said end face contact piece, said shaft holding member, and said adjusting screw are provided near each end portion of said guide shaft, and said screw hole is formed near each end portion of said guide shaft.

3. The guide shaft holding mechanism according to claim 1 or 2, comprising:
a spring for pressing a portion near the end face of said guide shaft in a downward direction.

4. A guide shaft holding mechanism for holding a pair of guide shafts which are provided in parallel on left and right sides of a pickup unit for an optical disk and supports said pickup unit over a chassis plate in a manner which allows said pickup unit to freely linearly reciprocate, said mechanism comprising:
a fixing holder member for fixing and holding one end portion of one of said guide shafts at a reference height over the chassis plate;
a hook-shaped shaft holding member formed by cutting and erecting a portion of said chassis plate closer to a center of said chassis plate than said end face of said guide shaft into a shape having a cut-out portion through which said guide shaft is passed in an engaged state and cutting away a lower portion of either a left or right side of a closed frame of said cut-out portion into an insertion opening through which said guide shaft is inserted into said cut-out portion, wherein said shaft holding member is provided at the other end portion of said one guide shaft and both end portions of said other guide shaft; and
an adjusting screw for preventing said guide shaft from being extracted through said insertion opening and adjusting a height of said guide shaft,
wherein a screw hole is provided immediately below said guide shaft near said shaft holding member of said chassis plate, and said adjusting screw is threaded into said screw hole from a lower surface of said chassis plate, and an end face of said adjusting screw protruding upward from said screw hole contacts said guide shaft.

5. An optical disk drive comprising said guide shaft holding mechanism according to claim 1, 2 or 4.
